(19) United States
(12) Patent Application Publication
(10) Pub. No.: US 2015/0245164 A1
(43) Pub. Date: Aug. 27, 2015

(54) INTERACTION BETWEEN WEARABLE DEVICES VIA BROADCASTED SENSOR-RELATED DATA

(71) Applicant: Christopher Merrill, San Francisco, CA (US)

(72) Inventor: Christopher Merrill, San Francisco, CA (US)

(73) Assignee: AliphCom, San Francisco, CA (US)

(21) Appl. No.: 14/191,284

(22) Filed: Feb. 26, 2014

(51) Int. Cl. H04W 4/00; H04W 64/00

(52) U.S. Cl. CPC H04W 4/008; H04W 4/003; H04W 64/00; H04W 4/005; H04W 84/18

(57) ABSTRACT

Techniques for performing interactions between wearable devices using broadcasted sensor-related data are described. Disclosed are techniques for receiving a broadcast data packet at a first device, the broadcast data packet including data identifying a second device and data associated with a motion detected at the second device. The data associated with the motion may be compared to reference data stored in a memory coupled to the first device to determine a match. An operation of the first device using the data identifying the second device may be executed. The operation may be used to perform an interaction between the first device and the second device.

### FIELD

Various embodiments relate generally to wearable electrical and electronic hardware, computer software, human-computing interfaces, wired and wireless network communications, telecommunications, data processing, and computing devices. More specifically, disclosed are techniques for performing interactions between wearable devices using broadcasted sensor-related data.

### BACKGROUND

With the increasing usage of smaller computing devices and wearable devices, allowing communication and interaction between the devices while maintaining low power consumption is increasingly important. Some conventional communication links between devices, such as Wi-Fi, consume relatively large amounts of power and are not well-suited for smaller computing devices. Other conventional communication links generally require less power but can only be used within a small range, for example, within 20 centimeters.

In one conventional approach, the Bluetooth® data communication protocol, maintained by Bluetooth Special Interest Group (SIG) of Kirkland, Wash., may provide a method for wireless communication up to about 10-15 meters, using less power. A drawback to this approach is that manual intervention or mandatory process typically is necessary to establish a connection between devices.

Thus, what is needed is a solution for performing interactions between wearable devices without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary wearable device with an interaction manager in some applications, according to some examples;

FIG. 2A illustrates an application architecture for an exemplary interaction manager, according to some examples;

FIG. 2B illustrates an example of reference data to be used with an interaction manager, according to some examples;

FIG. 3 illustrates an exemplary broadcast data packet configured to be used by an interaction manager, according to some examples;

FIG. 4 illustrates exemplary types of data associated with motion configured to be used by an interaction manager, according to some examples;

FIG. 5 illustrates exemplary data associated with motion configured to be used by an interaction manager, according to some examples;

FIG. 6 illustrates another exemplary data associated with motion configured to be used by an interaction manager, according to some examples;

FIG. 7 illustrates exemplary interactions performed by an interaction manager, according to some examples;

FIG. 8 illustrates an application architecture for a teaching and learning mode of an exemplary interaction manager, according to some examples;

FIG. 9 illustrates an exemplary process for an interaction manager, according to some examples;

FIG. 10 illustrates another exemplary process for an interaction manager, according to some examples;

FIG. 11 illustrates yet another exemplary process for an interaction manager, according to some examples;

FIGS. 12A and 12B illustrate exemplary processes for a teaching and learning mode of an interaction manager, according to some examples; and

FIG. 13 illustrates an exemplary computer system suitable for use with an interaction manager, according to some examples.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

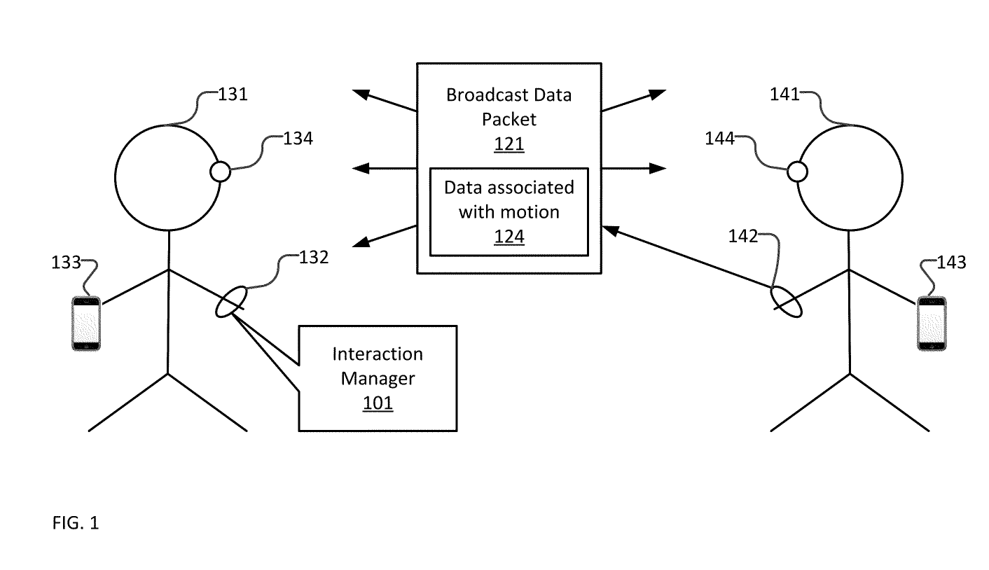

FIG. 1 illustrates an exemplary wearable device with an interaction manager in some applications, according to some examples. As shown, FIG. 1 includes an interaction manager 101, a broadcast data packet 121, data associated with motion 124, users 131 and 141, and wearable devices 132-134 and 142-144. In some examples, interaction manager 101 of wearable device 132 may receive broadcast data packet 121, which may include data identifying wearable device 142 and data associated with sensor-related input, such as data associated with motion 124, detected at wearable device 142. Broadcast data packet 121 is a data packet that may not have an intended recipient and may be simultaneously (or nearly simultaneously) sent to one or more devices. As shown, broadcast data packet 121 may be sent to wearable devices 132-134 and 143-144.

In some examples, broadcast data packet 121 may be transmitted between devices without having an established or secured communication link between the devices. An established communication link between devices may exist when the devices agree on an encryption protocol. In some examples, broadcast data packet 121 may be transmitted from the broadcast device to the recipient device without the broadcast device knowing or being aware of the identity of the recipient device. In some examples, broadcast data packet 121 may be communicated between devices without authentication or authorization between the devices.

A broadcast data packet may be, for example, an advertising packet using a Bluetooth® protocol. For example, in Bluetooth Specification Version 4.0, an advertising packet may be transmitted by a device to discover, connect, or send status or user data to other devices. Another device, which may be, for example, set to a receiving mode, such as a scanner mode or initiator mode, to receive the advertising packet. In such modes, a device may receive an advertising packet, may send a request, such as a connection request, to the transmitting device, and the like. If the transmitting device accepts a connection request, then a connection may be established. An advertising packet may be transmitted to another device up to about 10-15 meters away, when unobstructed. Broadcast data packet 121 may be transmitted using other protocols as well, including Wi-Fi, wireless local area network (WLAN), and other communication technologies. Data identifying wearable device 142 may include an identifier, a name, an address of wearable device 142, or the like. Data identifying a device may be, for example, a Bluetooth MAC address. A Bluetooth MAC address may be a 48-bit address, according to Bluetooth Specification Version 4.0. Bluetooth Specification Version 4.0, and all versions of Bluetooth specifications, including version 4.1, 3.0+HS (High Speed), 2.1+EDR (Enhanced Data Rate), 2.0+EDR, and all addendums, maintained by Bluetooth Special Interest Group (SIG) of Kirkland, Wash., are hereby incorporated by reference for all purposes.

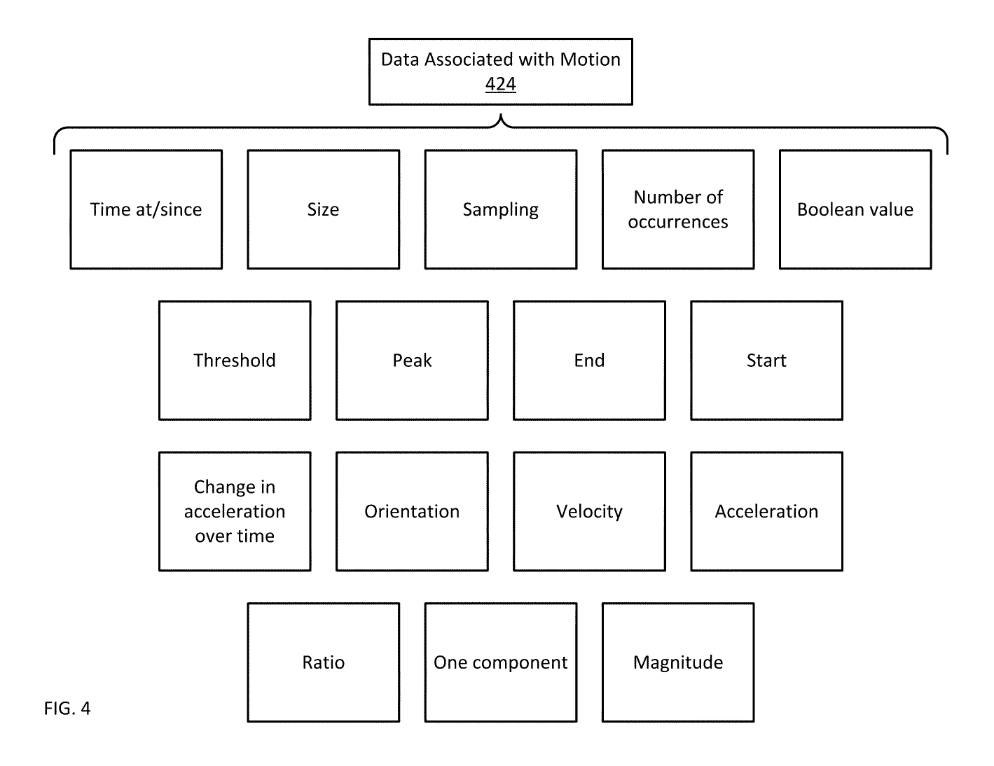

In some examples, interaction manager 101 may become aware of the identity of another device with which to perform an interaction as a result of or as a function of data associated with motion 124, or other data associated with sensor-related data. In some examples, interaction manager 101 may compare data associated with motion 124 to reference data stored in a memory coupled to wearable device 132 to determine a match. Data associated with motion 124 may include a variety of parameters relating to motion detected at wearable device 142 (see FIG. 4), such as, a time since the end of the motion, a size of a peak acceleration of the motion, a motion pattern, etc. The motion may be detected at wearable device 142 by one or more sensors, such as, an accelerometer, a gyroscope, an inertial sensor, other motion sensors, and the like. The sensors may be local or internal to wearable device 142 (e.g., an accelerometer integrated with wearable device 142), or remote or external to wearable device 142 (e.g., an accelerometer integrated with wearable device 143 or 144, or another device (not shown)). Still, other sensor-related data that may be sensed or detected by one or more sensors coupled to or in data communication with wearable device 142 may be used. For example, location data detected by a Global Positioning System (GPS) may be used to determine a distance between wearable devices 132 and 142. As another example, audio or voice data detected by a microphone may be used to determine a voice command or ambient sound. As another example, heart rate data detected by a heart rate sensor may be used. Reference data may be data associated with motion that corresponds to or is associated with one or more predetermined interactions or interactive operations. For example, a motion pattern (e.g., three shakes) may correspond with creating a communication link between wearable devices 132 and 142. As another example, another motion pattern (e.g., a high-five) may correspond to joining users 131 and 141 of wearable devices 132 and 142 in a competition or challenge (e.g., a race to complete 1000 steps). As another example, reference data may be given as a range. For example, a reference may be a motion pattern with three shakes, each shake having a peak acceleration of 15 to 20 m/s². As another example, the reference may have three shakes, each shake within 1 to 1.5 seconds of each other. Still, reference data may include other sensor-related data. For example, a reference data or pattern may include a motion pattern and a location threshold (e.g., three shakes, plus distance between devices under 10 feet). For example, a reference data may include a location parameter and a heart rate parameter (e.g., distance between devices being 5 to 10 feet, and the difference between heart rates detected at devices being 10%).

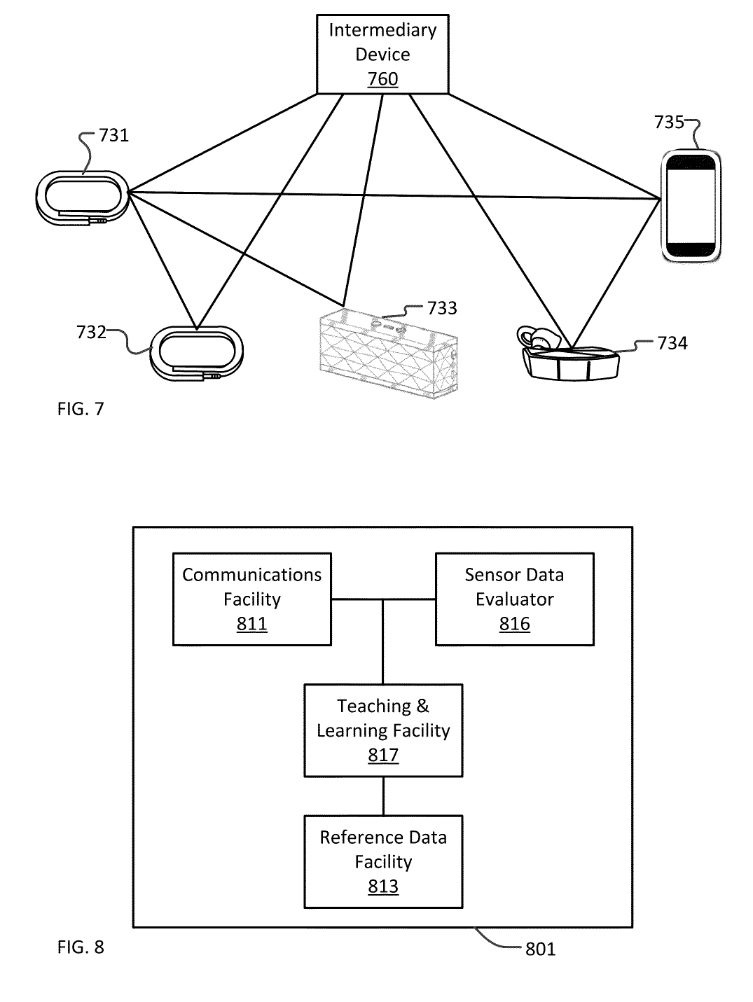

In some examples, after determining a match, interaction manager 101 may execute an operation of wearable device 132 using data identifying wearable device 142. A match may indicate substantial similarity between data associated with motion 124 and the reference data. A match also may be determined if data associated with motion 124 and the reference data are within a certain tolerance. A tolerance (or range of tolerances) may expressed as a number (e.g., 0.3 seconds, 0.4 m/s², etc.), as a percentage (e.g., 1%), or another method. As described above, the operation may be an interactive operation corresponding to the reference data. The operation may be a variety of operations relating to an interaction between wearable device 132 and 142 (see FIG. 7), such as, pairing wearable devices 132 and 142 for Bluetooth communication, adding user 141 of wearable device 142 to a friend list or social network of user 131 of wearable device 132, sending status or user data (e.g., vital data received or detected at wearable device 132) from wearable device 132 to wearable device 142, etc. The operation may use data identifying wearable device 142 to identify and involve wearable device 142 in the interactive operation.

Wearable devices 132-134 and 142-144 may be may be worn on or around an arm, leg, ear, or other bodily appendage or feature, or may be portable in a user's hand, pocket, bag or other carrying case. As an example, a wearable device may be a data-capable band 132 and 142, a smartphone 133 and 143, and a headset 134 and 144. Other wearable devices such as a watch, data-capable eyewear, cell phone, tablet, laptop or other computing device may be used.

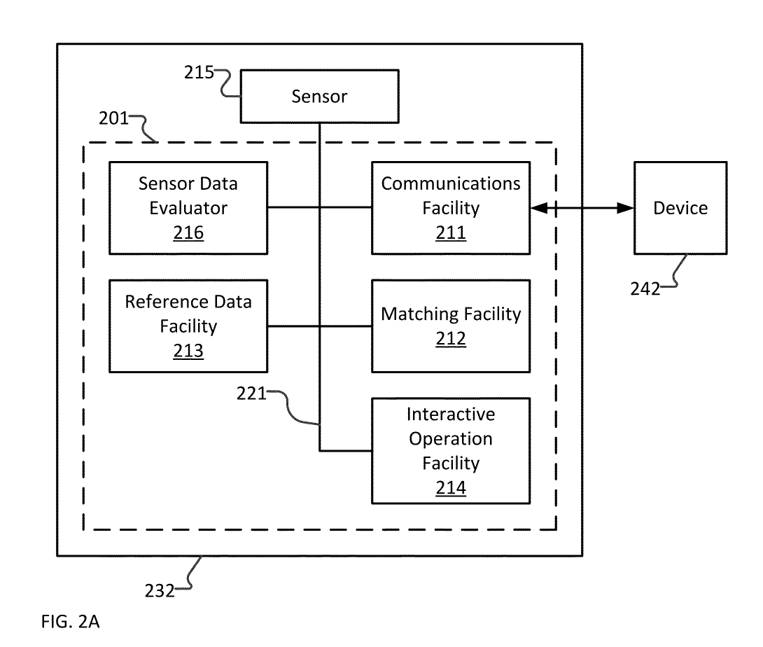

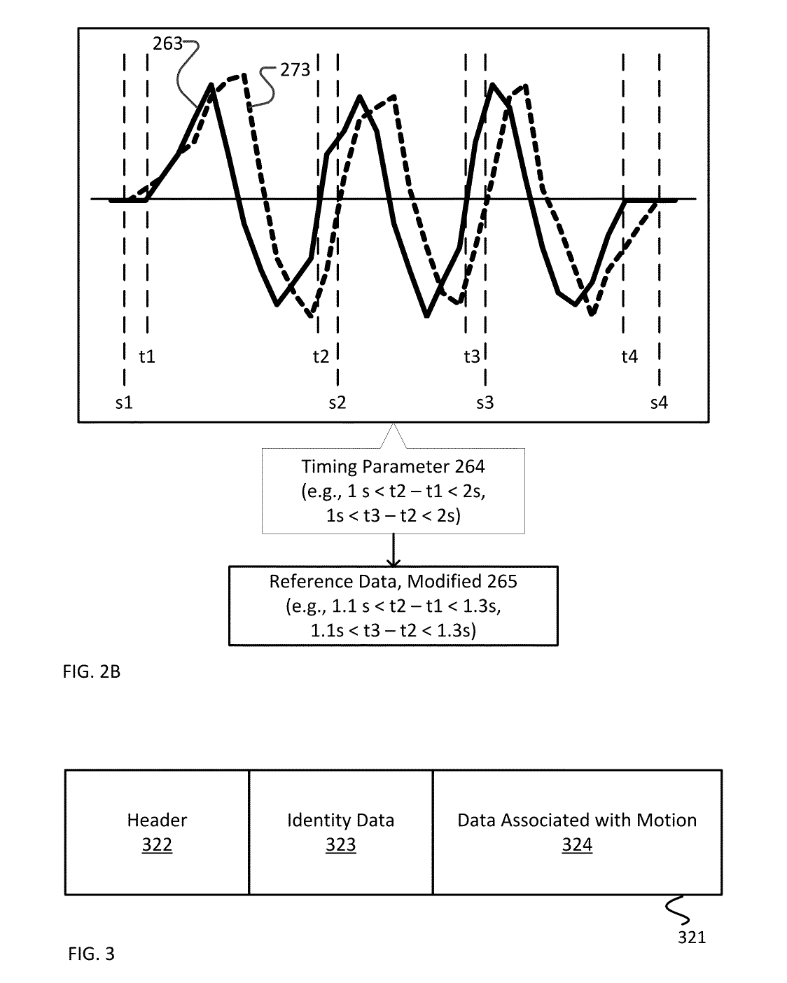

FIG. 2A illustrates an application architecture for an exemplary interaction manager, according to some examples. As shown, a first device includes a bus 221, a sensor 215, and an interaction manager 201. Interaction manager 201 includes communications facility 211, matching facility 212, reference data facility 213, interactive operation facility 214, and sensor data evaluator 216. As used herein, “facility” refers to any, some, or all of the features and structures that are used to implement a given set of functions, according to some embodiments. In some examples, sensor 215 may be implemented or integrated as part of interaction manager 201, or may be remote from first device 232. In some examples, all or some of communications facility 211, matching facility 212, reference data facility 213, interactive operation facility 214, and sensor data evaluator 216 may be implemented or integrated with interaction manager 201 and first device 232 (as shown) or may be remote or distributed. First device 232 may receive a broadcast data packet from a second device 242.

Communications facility 211 may include a wireless radio, control circuit or logic, antenna, transceiver, receiver, transmitter, resistors, diodes, transistors, or other elements that are used to transmit and receive data, including broadcast data packets, from other devices. In some examples, communications facility 211 may be implemented to provide a “wired” data communication capability such as an analog or digital attachment, plug, jack, or the like to allow for data to be transferred. In other examples, communications facility 211 may be implemented to provide a wireless data communication capability to transmit digitally encoded data across one or more frequencies using various types of data communication protocols, such as Bluetooth, without limitation. For example, communications facility 211 may be configured to receive a broadcast data packet from second device 242. The broadcast data packet may include data identifying second device 242 and data associated with motion detected at second device 242.

Matching facility 212 may be configured to compare the data associated with the motion detected at second device 242 with reference data stored in reference data facility 213 to determine a match. In some examples, reference data facility 213 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Reference data facility 213 may also be implemented on a memory having one or more partitions that are configured for multiple types of data storage technologies to allow for non-modifiable (i.e., by a user) software to be installed (e.g., firmware installed on ROM) while also providing for storage of captured data and applications using, for example, RAM. Once captured and/or stored in reference data facility 213, data may be subjected to various operations performed by other elements of interaction manager 201 or first device 232 (e.g., adaptation as described with respect to FIG. 8, or others). Reference data may be sensor-related data, such as, data associated with motion, that corresponds to or is associated with one or more predetermined interactions or interactive operations. Matching facility 212 may determine a match if the data associated with motion detected at second device 242 and the reference data are substantially similar or are similar within a tolerance.

Interactive operation facility 214 may be configured to execute an operation of first device 232 using the data identifying second device 242. They operation may be an interactive or joint operation to be performed by first device 232 and second device 242. For example, interactive operation facility 214 may use the data identifying second device 242 to create or establish a secure connection to second device 242. For example, interactive operation facility 214 may transmit a signal to a server or other intermediary device to add the user of second device 242 to a friend list of the user of first device 232, using the data identifying second device 242. The signal transmitted may include the data identifying second device 242, which is then used by the server to identify the user of second device 242. The server may host, be operated by, or be in communication with a social media or networking-related service, such as Internet-based Social Networking Services (“SNS”), e.g., Facebook® of Menlo Park, Calif., Twitter® of San Francisco, Calif., etc. Still, other interactions may be performed.

Sensor 215 may be various types of sensors and may be one or more sensors. Sensor 215 may be configured to detect or capture an input to be used by interaction manager 201, such as, for creating, generating, modifying, or customizing reference data stored in reference data facility 213, for generating or determining data associated with the input to be transmitted to another device using communications facility 211, etc. For example, sensor 215 may detect an acceleration (and/or direction, rate of change in direction, distance, speed, velocity, etc.) of a motion over a period of time. In some examples, sensor 215 may include an accelerometer. An accelerometer may be used to capture data associated with motion detection along 1, 2, or 3-axes of measurement, without limitation to any specific type of specification of sensor. Accelerometer 302 may also be implemented to measure various types of user motion and may be configured based on the type of sensor, firmware, software, hardware, or circuitry used. In some examples, sensor 215 may include a gyroscope, an inertial sensor, or other motion sensors. In other examples, sensor 215 may include an altimeter/barometer, light/infrared (“IR”) sensor, pulse/heart rate (“HR”) monitor, audio sensor (e.g., microphone, transducer, or others), pedometer, velocimeter, GPS receiver or other location sensor, thermometer, environmental sensor, or others. An altimeter/barometer may be used to measure environmental pressure, atmospheric or otherwise, and is not limited to any specification or type of pressure-reading device. An IR sensor may be used to measure light or photonic conditions. An audio sensor may be used to record or capture sound. A pedometer may be used to measure various types of data associated with pedestrian-oriented activities such as running or walking. A velocimeter may be used to measure velocity (e.g., speed and directional vectors) without limitation to any particular activity. A GPS receiver may be used to obtain coordinates of a geographic location using, for example, various types of signals transmitted by civilian and/or military satellite constellations in low, medium, or high earth orbit (e.g., “LEO,” “MEO,” or “GEO”). In some examples, differential GPS algorithms may also be implemented with a GPS receiver, which may be used to generate more precise or accurate coordinates. In other examples, a location sensor may be used to determine a location within a cellular or micro-cellular network, which may or may not use GPS or other satellite constellations. A thermometer may be used to measure user or ambient temperature. An environmental sensor may be used to measure environmental conditions, including ambient light, sound, temperature, etc. Still, other types and combinations of sensors may be used.

Sensor data evaluator 216 may be configured to evaluate, process, or analyze the sensor-related data received from sensor 215. Sensor data evaluator 216 may be configured to determine or generate one or more parameters, values, or features associated with the sensor-related data detected at first device 232. In some examples, a motion may be detected by sensor 215. Sensor data evaluator 216 may determine a variety of parameters associated with motion (see FIG. 4), such as, a first time at which motion is detected or starts, a second time since an end of the motion, a size of a peak of an acceleration of the motion, a sampling of an acceleration of the motion at a predetermined frequency or sample rate (e.g., 3 times per second), etc.

In some examples, sensor data evaluator 216 may further be configured to compare the data associated with motion detected at first device 232 to reference data stored in reference data facility 213 to determine a match. A match may be found if the data associated with motion detected at first device 232 falls within the range of the reference data, is within a certain tolerance of the reference data, or is otherwise substantially similar to the reference data. For example, FIG. 2B includes reference data having acceleration pattern 263, reference data having timing parameter 264, and acceleration data 273 detected by sensor 216. As shown, for example, acceleration pattern 263 may be a pattern indicating three shakes, with the first shake being from t1 to t2, the second shake from t2 to t3, and the third shake from t3 to t4. As shown, for example, timing parameter 264 may require that each shake be within 1 to 2 seconds of each other (e.g., is <t2−t1<2 s, is <t3−t2<2 s). As shown, for example, acceleration data 273 detected by sensor 216 may also indicate three shakes, with the first shake being from s1 to s2, the second shake from s2 to s3, the third shake from s3 to s4. Sensor data evaluator 216 may determine that s2 is 1.1 seconds after s1, and s3 is 1.3 seconds after s2. Then matching facility 212 may determine a match. If a match is found, interaction manager 201 may be set to a receiving mode, so that communications facility 211 may receive, scan, or listen for a broadcast data packet.

In some examples, if a match is found, interaction manager 201 may further modify or customize the reference data using the data associated with the motion detected at first device 232. The reference data after modification may be configured to be compared with the data associated with motion detected at second device 242, as described above. Since the reference data after modification may incorporate or include data associated with motion detected at first device 232, a match found by matching facility 212 between the reference data and the data associated with motion detected by second device 242 may indicate a similarity between the data associated with motion detected at first device 232 and the data associated with motion detected by second device 242. For example, FIG. 2B, described above, also includes modified reference data 265. Continuing the example above, acceleration pattern 263 of the reference data may be a pattern of three shakes, and timing parameter 264 of the reference data may indicate that each shake be within 1 to 2 seconds of each other. The reference data may be modified, for example, using the times between the shakes detected by sensor 215. For example, the range of times in timing parameter 264 may be modified to be the actual times detected, such as, the time between s1 and s2 and the time between s2 and s3. For example, as described above, sensor data evaluator 216 may determine that s2 is 1.1 seconds after s1, and s3 is 1.3 seconds after s2. Thus, as shown, modified reference data 265 may have a timing parameter requiring each shake to be within 1.1 to 1.3 seconds of each other. A similar modification to the reference data may be made using another parameter associated with motion. As another example, sensor data evaluator 216 may determine that a time since a high-five motion detected at first device 232 is 0.7 seconds, and determine a match with a high-five reference in reference data facility 213. Sensor data evaluator 216 may modify the high-five reference by adding a time parameter, e.g., a high-five motion that was detected 0.7 seconds before the receipt of a broadcast data packet at communications facility 211. Sensor data evaluator 216 may also modify the high-five reference with a time range, e.g., a high-five motion that was detected between 3:16 p.m. and 3:17 p.m. Communications facility 211 may receive a broadcast data packet including data identifying second device 242 and data associated with motion detected at second device 242. Matching facility 212 may compare the data associated with motion detected at second device 242 to the reference data at device 232 with the added parameter, e.g., a high-five motion that is detected 0.7 seconds since the receipt of a broadcast data packet. If there is substantial similarity (e.g., substantial similarity in acceleration, velocity, direction, timing, etc.), matching facility 212 may determine a match. Thus, matching facility 212 may compare the time since the end of the motion detected at first device 232 and the time since the end of the motion detected at second device 242. In this example, interaction facility 201 may execute or perform an interaction between first device 232 and second device 242 if a motion detected on first device 232 and second device 242 occur at substantially the same time.

In some examples, after sensor data evaluator 216 determines data associated with motion detected at first device 232, communications facility 215 may be configured to transmit a broadcast data packet that includes data identifying first device 232 and the data associated with motion detected at a first device 232. Communications facility 215 may transmit this broadcast data packet substantially simultaneous with, before, or after receiving the broadcast data packet from second device 242. The broadcast data packet transmitted by communications facility 215 may be received by second device 242. Second device 242 may include an interaction manager, and process the broadcast data packet from first device 232 in a similar fashion.

In still other examples, interaction manager 201 and the above-described elements may be implemented in hardware, software, firmware, circuitry, or a combination thereof. Interaction manager 201 and the above-described elements may be varied in function, structure, configuration, or implementation and are not limited to those shown and described.

FIG. 3 illustrates an exemplary broadcast data packet configured to be used by an interaction manager, according to some examples. As shown, broadcast data packet or advertising packet 321 includes a header 322, data identifying the broadcaster, advertiser, or sender 323, and data associated with motion detected at the sender 324. Header 322 may include basic information such as the type of broadcast data packet 321, and the length of broadcast data packet 321. Data identifying the sender or identity data 323 may include a name, address, or other identifier associated with the sender, e.g., a Bluetooth MAC address, a Wi-Fi MAC address, etc. Identity data 323 may be included in header 322 or may be apart from or additional to header 322. Data associated with motion 324 may be one or more parameters associated with motion detected at the sender, as described above. Still, broadcast data packet 321 may include other data, such as, data associated with other sensor-related data (e.g., location, sound, etc.), a control signal indicating an interactive operation associated with the data associated with motion 324, an acknowledgement code, and the like.

FIG. 4 illustrates exemplary types of data associated with motion configured to be used by an interaction manager, according to some examples. As shown, data associated with motion 424 may be one or more parameters, or a combination of parameters, including time since/at, size, sampling, number of occurrences, Boolean value, threshold, peak, end, start, acceleration, orientation, velocity, change in acceleration over time, ratio, one component, and magnitude. “Time at” may be the time at which a motion, or a parameter of the motion, occurs, and “time since” maybe the time that has passed since that motion. Both “time at” and “time since” may depend on an internal clock. “Size” may be a magnitude or amplitude of a motion, or a parameter of the motion. It may be given in a certain unit, such as, m/s², m/s, etc. “Sampling” may be a continuous detection of a motion, or a parameter of the motion, at a certain frequency. The frequency may be predetermined, variable, or fixed. “Number of occurrences” may be a number of a certain parameter of the motion, e.g., a number of times that the acceleration of the motion exceeds 11 m/s². “Boolean value” may be a binary value, or a true/false value, indicating the presence or absence of a parameter of a motion, or the true or false of a statement about a motion or a parameter of the motion. “Threshold” may be a value of a parameter of a motion that triggers an event, e.g., the measurement or determination of another parameter, to happen or cease to happen. For example, a crossing of a threshold may trigger a determination of the time of the crossing. The threshold may be a maximum, minimum, or range of values. “Peak” may be a maximum or minimum value of a parameter of a motion, e.g., the maximum acceleration of the motion. “End” and “Start” may be the end and start of a motion, e.g., a transition from motion to rest, or a transition from rest to motion, respectively. “Acceleration” may be a change in velocity, and may be expressed in m/s² or other similar units, and as a scalar magnitude or number, or as a vector having a plurality of axes or components. “Velocity” may be a change in position, and may be expressed in m/s or other similar units, and as a number or a vector. “Orientation” may be a position or alignment of an object, e.g., a device having an interaction manager, with respect to a reference, e.g., the center of the Earth. “Change in acceleration over time” may be expressed in m/s² and as a number or a vector, and may be used for determining a an abrupt change in acceleration, such as, an abrupt stop, or an impact with another object. “One component” may refer data associated with motion that depends or relies on one component of a vector, for example, the x-axis of acceleration. “Magnitude” may refer to data associated with motion that depends on a magnitude of a vector, or a scalar magnitude. Magnitude may be determined from the x, y, and z axes by using the formula \sqrt{x²+y²+z²}. Data associated with motion 424 may use a combination of parameters. For example, data associated with motion 424 may be a time since an end of the motion, a size of a peak of an acceleration associated with the motion, a ratio of the x-axis of the velocity to the y-axis of velocity associated with the motion, a sampling of the acceleration of the motion, a number of times an acceleration exceeds a threshold, etc. Still, other parameters may be used.

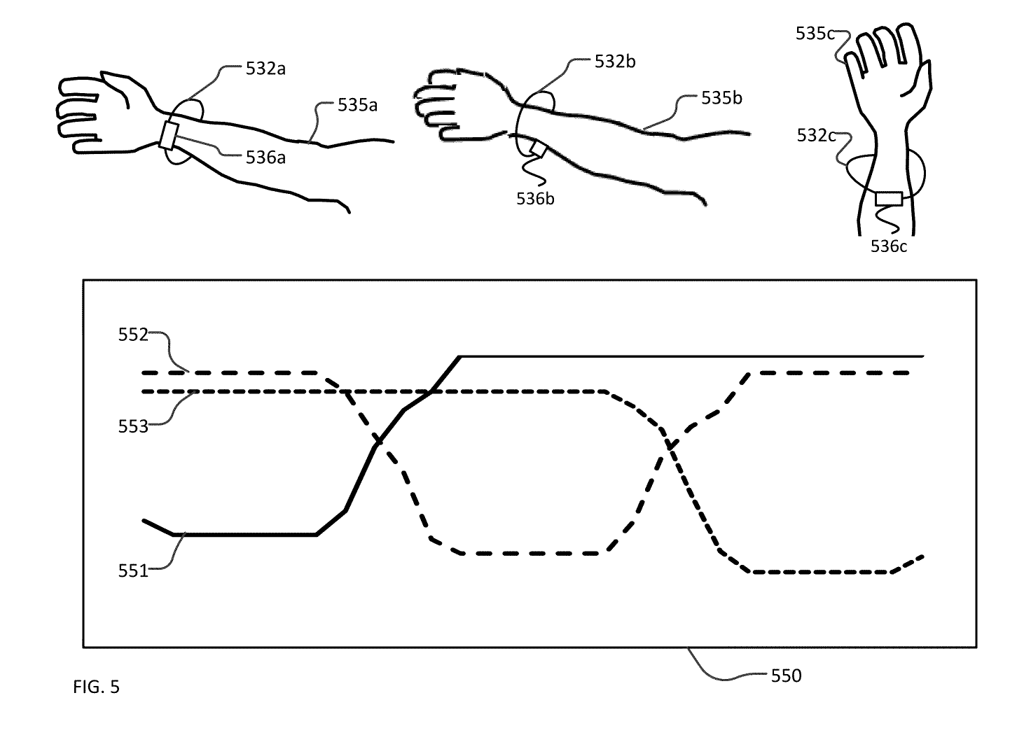

FIG. 5 illustrates exemplary data associated with motion configured to be used by an interaction manager, according to some examples. As shown, FIG. 5 includes a user's arm 535a-c, a wearable device or data-capable band 532a-c, and a bottom of the wearable device 536a-c. FIG. 5 also includes data associated with motion 550, including an acceleration in the x-axis 551, an acceleration in the y-axis 552, and an acceleration in the z-axis 553. The acceleration may be detected by a 3-axis accelerometer (not shown) coupled to wearable device 532a-c. The accelerometer may detect an acceleration caused by gravity in the direction pointing towards the center of the Earth. Wearable device 532a-c may change orientation with the user's motion, e.g., by conforming with the shape and size of the user's arm. As shown, arm 535a is extended sideways, and wearable device 532a is positioned such that bottom 536a is facing the sideways. In this position, the x-axis of the accelerometer may be pointing towards the center of the Earth, or downwards. In this position, data associated with motion 550 may show that the x-component 551 detects an acceleration (e.g., the acceleration caused by gravity), while the y-component 552 and z-component 553 detect near zero or substantially smaller acceleration. In another orientation, arm 535b is twisted such that it is extended sideways, and wearable device 532b is positioned such that bottom 536b is facing downwards. In this position, the y-axis of the accelerometer may be pointing towards the center of the Earth. In this position, data associated with motion 550 may show that the y-component 552 detects an acceleration (e.g., the acceleration caused by gravity), while the x-component 551 and z-component 553 detect near zero or substantially smaller acceleration. Finally, arm 535c is shown to be raised such that it is pointing upwards, and wearable device 532c is positioned such that bottom 536c is facing sideways. In this position, the z-axis of the accelerometer may be pointing towards the center of the Earth. In this position, data associated with motion 550 may show that the z-component 553 detects an acceleration (e.g., the acceleration caused by gravity), while the x-component 551 and y-component 552 detect near zero or substantially smaller acceleration. As shown in the data associated with motion 550, the x-component 551 is negative at the beginning, the y-component 552 is negative in the middle, and the z-component 553 is negative at the end. Data associated with motion 550 may include various parameters, such as, a time when the x-component 551 changes from negative to substantially zero, a ratio between the x-component 551 and the y-component 552, a size of the peak acceleration in the z-component 553, and the like. Data associated with motion 550 may be received at another device and compared to reference data to determine whether to perform or execute an interaction between two devices.

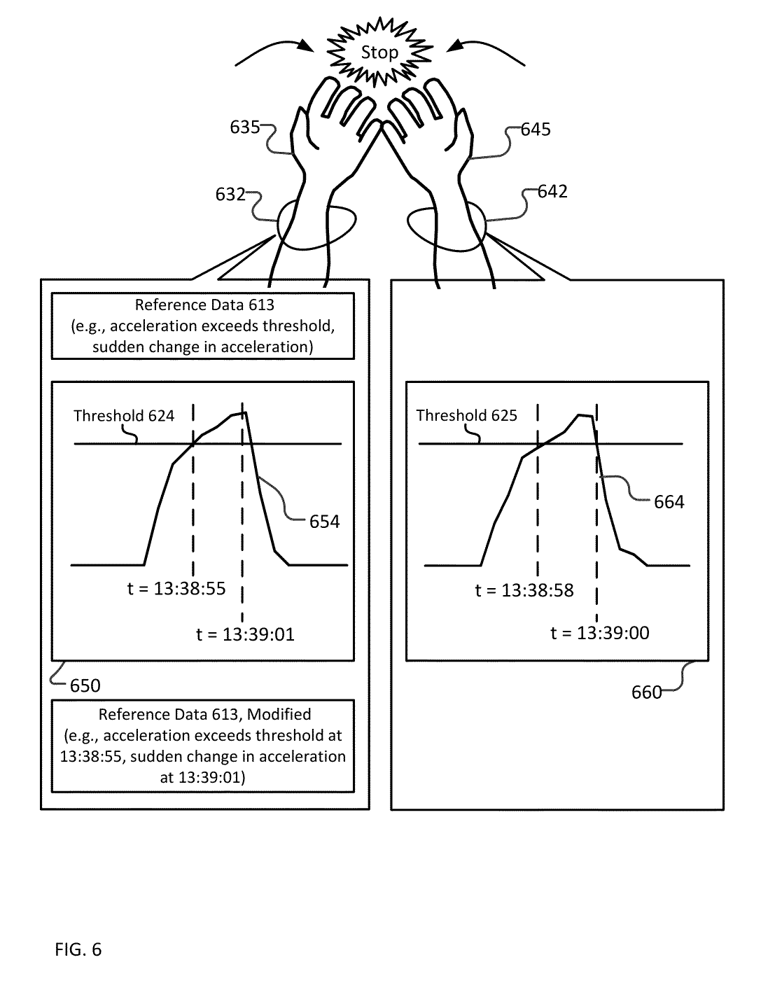

FIG. 6 illustrates another exemplary data associated with motion configured to be used by an interaction manager, according to some examples. As shown, FIG. 6 includes a first user's arm 635, a first device 632, a second user's arm 645, and a second device 642. FIG. 6 also includes reference data 613 stored in a memory coupled to first device 632, data associated with motion 650 detected at first device 632, a magnitude of a parameter of the motion 654, e.g., acceleration as a function of time, and threshold 624. FIG. 6 also includes data associated with motion 660 detected at second device 642, a magnitude of a parameter of the motion 664, e.g., acceleration as a function of time, and threshold 625. Accelerations 654 and 664 may be detected by an accelerometer coupled to first device 632 and second device 642, respectively. Here, the first user and the second user may be giving each other a high-five. Arms 635 and 645 may both be raised and move towards each other, with slowly increasing acceleration. Hands of arms 635 and 645 may hit each other, making an impact and an abrupt stop, resulting in a sudden change in acceleration. As shown, reference data 613 may include an acceleration exceeding a threshold 624, and a subsequent sudden change in acceleration. As shown, acceleration 654 indicates a slow increase at the beginning, and then a sudden change near the end. Acceleration 654 exceeds threshold 624 at a time 13:38:55, and acceleration has a sudden change at time 13:39:01. Data associated with motion 550 may include various parameters, such as, the magnitude of acceleration 654, the change in acceleration 654, the time at which acceleration 654 exceeds threshold 624, the time at which acceleration 654 has a sudden change. Data associated with motion 550 may also include other parameters, such as, a Boolean value indicating whether the change in acceleration 654 over time exceeds a threshold, a size of the peak of acceleration 654, a time since a beginning of the increase in acceleration 654, and the like. As shown, reference data 613 may be modified by data associated with motion 550. For example, reference data 613 may be modified to include the time at which acceleration 654 exceeds threshold 624 and the time at which a sudden change in acceleration 654 occurs. Reference data of second device 642 may have threshold 625, which may be the same as (as shown) or different from threshold 624. As shown, acceleration 664 indicates a slow increase at the beginning, and then a sudden change near the end. Acceleration 664 exceeds threshold 625 at a time 13:38:58, and acceleration has a sudden change at time 13:39:00. Data associated with motion 660 may include the time that acceleration 664 exceeds threshold 625 and the time at which acceleration has a sudden change. A broadcast data packet containing the identity of second device 642 and data associated with motion 660 may be received by first device 632. First device 632 may compare the modified reference data 613 (e.g., acceleration exceeds threshold at 13:38:55 and sudden change in acceleration at 13:39:01) to data associated with motion 660 (e.g., acceleration exceeds threshold at 13:38:58 and sudden change in acceleration at 13:39:00). First device 632 may determine that there is a match within a tolerance. First device 632 may then perform an interaction with second device 642. By modifying reference data 613 with data associated with motion 650, a comparison of the modified reference data 613 with data associated with motion 660 may incorporate a comparison of data associated with motion 650 with data associated with motion 660. First device 632 may determine whether to perform an interaction with second device 642 as a function of whether there is a match between data associated motion 650 detected by first device 632 and data associated with motion 660 detected by second device 642.

FIG. 7 illustrates exemplary interactions performed by an interaction manager, according to some examples. As shown, FIG. 7 includes devices 731-735 and intermediary device or node 760. Devices 731-735 may be a variety of computing devices, including a headset, a data-capable band, a media device or speaker box, a smartphone or cell phone, a laptop or computer, and the like. A device may perform an interaction with another device directly or indirectly. An interaction may rely on or use at least two devices. An interactive operation may be an operation executed by one of the devices using identity data of another device in order to perform the interaction. Data may be sent and received between devices using a number of wired or wireless protocols, such as Bluetooth, Wi-Fi, 3G, 4G, and others. Direct interaction may occur when a device creates or establishes a direct connection or a peer-to-peer communication link with another device. Indirect interaction may occur when a device interacts or performs a joint activity with another device through an intermediary device or node 760, or when a peer-to-hub communication link is used. Intermediary device 760 may be one or more servers or other computing devices. For example, an interaction between devices 731-732 may be a pairing between devices 731-732 to create a secure Bluetooth connection, and device 731 may create a peer-to-peer connection by sending a data signal to device 732. As another example, device 731 may interact with device 732 by adding device 732, or the user of device 732, to a social network. Device 731 may send a control signal to intermediary device 760, wherein intermediary device 760 hosts or is in data communication with a social network. The control signal may instruct intermediary device 760 to add a friend to the social network, using the identity data of device 732 to identify the device to be added. As another example, the users of device 731 and device 732 may join a competition, for example, for who attains a higher heart rate during a marathon. Users of device 731 and device 732 may give each other a high-five at the start line of the marathon. The high-five motion may be detected at device 731 and device 732. Device 732 may determine a duration from when the high-five motion was detected by device 732 to when a broadcast data packet is transmitted from device 732, e.g., 0.65 seconds. Device 731 may determine another duration from when the high-five motion was detected by device 731 to when another broadcast data packet is transmitted from device 731, e.g., 0.62 seconds. Device 731 may receive the broadcast data packet from device 732. Device 731 may compare the two times, e.g., 0.65 seconds and 0.62 seconds, and determine that there is a match within a tolerance. Device 731 may send a control signal to intermediary device 760 in real-time or subsequently, e.g., after the marathon, to join device 732 in a competition. During the competition, device 732 may detect and record a heart rate and transmit this information to intermediary device 760 in real-time or later. Device 731 may receive information on the heart rate of the user of device 732 from intermediary device 760 in real-time or later. Device 731 may rank which user has a higher heart rate during the competition, or portions of the competition. In some examples, intermediary device 760 may be a server that uses a high-power data communication protocol that has a large range, such as, Wi-Fi, 3G, 4G, etc. Thus, device 731 and device 732 may communicate in real-time with intermediary device 760 over large distances, but power consumption on device 731 and device 732 will be high. In other examples, intermediary device 760 may be a node that uses a low-power data communication protocol that has a smaller range, such as, Bluetooth. Thus, while device 732 is within range of intermediary device 760, device 732 may communicate with intermediary device 760. For example, device 732 may transfer heart rate information as well as the identity data of device 731 to intermediary device 760. Device 731 may not be in range of intermediary device 760 at this time. When device 731 comes within range of intermediary device 760, intermediary device 760 may identify device 731 using the identity information, and transmit the heart rate information received from device 732 to device 731. Thus device 731 may receive information indirectly from device 732 during the competition using a low-power data communication protocol. Still, other interactions and communication protocols may be used.

FIG. 8 illustrates an application architecture for a teaching and learning mode of an exemplary interaction manager, according to some examples. Here, interaction manager 801 includes communications facility 811, sensor data evaluator 816, teaching and learning facility 817, and reference data facility 813. In a teaching mode, interaction manager 801 may be configured to detect sensor-related input, and create a new reference using data associated with the sensor-related input. A user may use the teaching mode to create new reference data. In some examples, a sensor (not shown) may detect a sensor-related input, e.g., motion. Sensor data evaluator 816 may analyze or process the sensor-related input to generate data associated with the sensor-related input, e.g., a peak acceleration. Teaching and learning facility 817 may create a new reference using the data associated with the sensor-related input, and store the new reference in reference data facility 813.

In a learning mode, interaction manager 801 may be configured to receive a new reference from another device using communications facility 811. A user may use the learning mode to receive new reference data from another user. In some examples, communications facility 811 may receive new reference data from another device. Teaching and learning facility 817 may create a new reference and store it in reference data facility 813. In some examples, a first device may enter a teaching mode. The user of the first device may do a “secret handshake” (e.g., a combination of a high-five, a fist-bump, and a wave), which is detected by the first device. The first device may create a new reference corresponding to the secret handshake and store the reference in its reference data facility. A second device may enter a learning mode. The second device may receive the reference data corresponding to the secret handshake from the first device, and may then create and store a new reference in its reference data facility. Still, other methods for creating and storing reference data are possible.

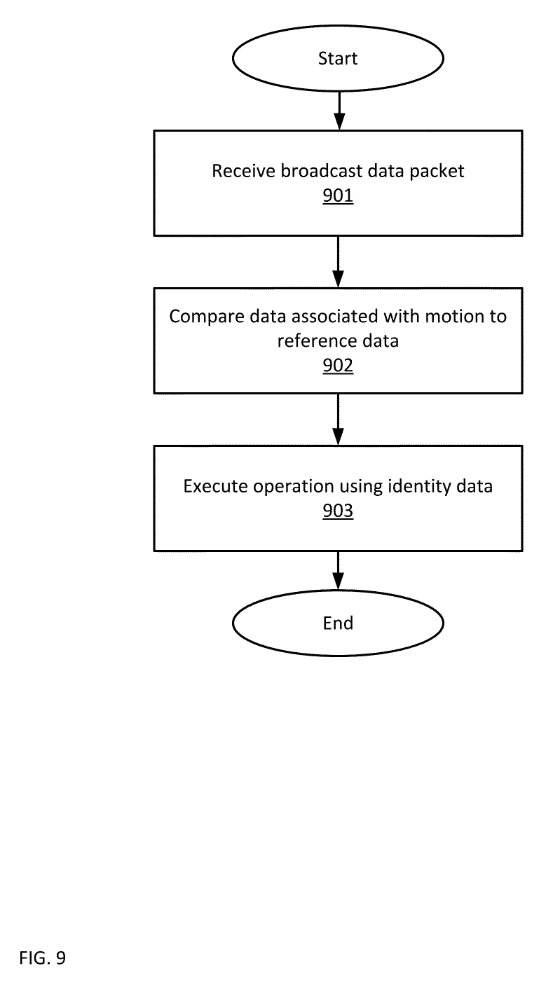

FIG. 9 illustrates an exemplary process for an interaction manager, according to some examples. At 901, a broadcast data packet is received at a first device. The broadcast data packet may contain data identifying a second device and data associated with motion detected at the second device. The broadcast data packet is a data packet that may be simultaneously transmitted to one or more devices, and may be transmitted to a device without an established connection to the device. The broadcast data packet may be transmitted to a device up to 10-15 feet away. The broadcast data packet may be used to establish a connection, including a secure or encrypted connection, between two devices. For example, a broadcast data packet may be a Bluetooth advertising packet. At 902, the data associated with motion is compared to reference data stored in a memory coupled to the first device to determine a match. A match may be a substantial similarity between the data associated with motion and the reference data. Reference data may be data associated with motion that corresponds to or is associated with an interaction or interactive operation. One or more reference data may be stored in a library or database. One or more comparisons with one or more reference data may be made before determining a match. At 903, an operation is executed using the data identifying the second device. The data identifying the second device may be used to identify the device for performing an interaction or interactive operation, such as, pairing or creating a connection with the second device, joining the second device in a joint activity or a competition, and the like. Still, other implementations may be possible.

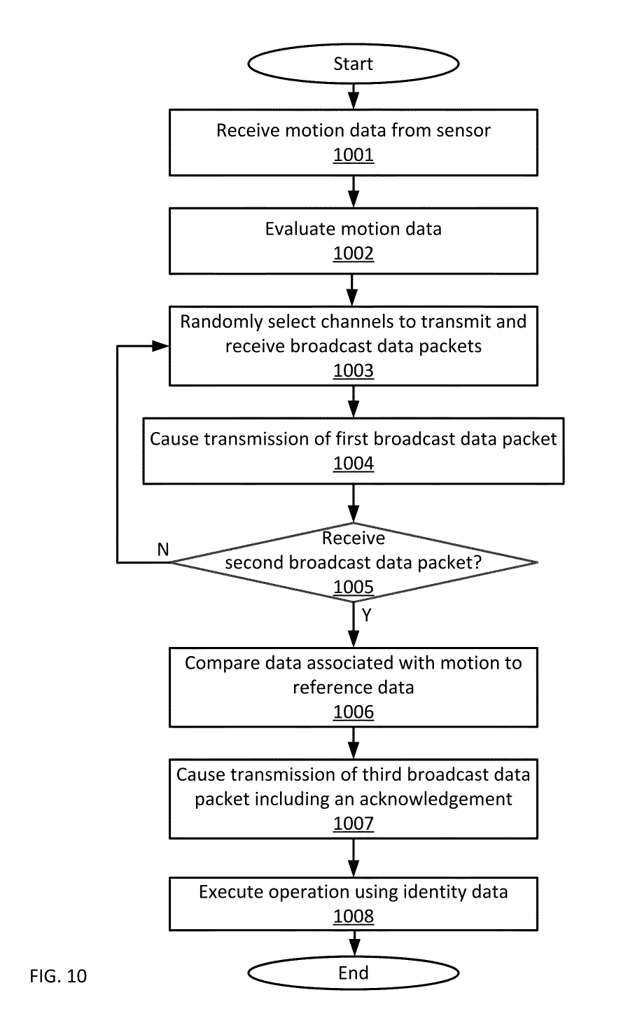

FIG. 10 illustrates another exemplary process for an interaction manager, according to some examples. At 1001, motion data may be received at a sensor coupled to a first device. In one example, the sensor may be a 3-axis accelerometer, and the motion data may be three components of acceleration associated with the motion. At 1002, the motion data may be processed or evaluated to generate data associated with motion. This may be, for example, a time at which a component of the acceleration passed a threshold, a time since a magnitude of the acceleration reached a peak, and the like, as previously described. At 1003, a channel may be randomly selected to transmit a broadcast data packet, and a channel may be randomly selected to receive a broadcast data packet. A channel may be a transmission path between two devices, and for wireless transmission, may be identified by a specific frequency or frequency range. For example, Bluetooth may define 79 channels for communication on the 2.4 GHz band, each channel separated by 1 MHz. In another example, Bluetooth may define 40 channels, each channel separated by 2 MHz. In Bluetooth Specification Version 4.0, there are three advertising channels and thirty-seven data channels. An advertising packet may be sent or received on an advertising channel. At 1004, transmission of a first broadcast data packet including data identifying the first device and data associated with motion detected at the first device is caused. At 1005, an inquiry is made as to whether a second broadcast data packet was received from a second device. The second broadcast data packet may include data identifying the second device and data associated with motion detected at the second device. In some examples, a device may not simultaneously transmit and receive data on the same channel. If the first device and the second device both transmit a broadcast data packet on the same channel, they may not be able to receive the broadcast data packet from each other. If the answer to the inquiry is no, the process repeats at 1003, and another channel may be randomly selected to transmit and another channel may be randomly selected to receive. The process may repeat this until a second broadcast data packet is received, or up to a maximum number of attempts, e.g., three attempts. If the answer to the inquiry is yes, the process moves to 1006. As described above, the data associated with motion detected at the second device is compared with reference data stored in a memory coupled to the first device to determine a match. At 1007, transmission of a third broadcast data packet including an acknowledgement of the receipt of the second broadcast data packet may be caused. The third broadcast data packet may further include the data identifying the second device. Similarly, fourth data packet including an acknowledgement of the receipt of the first broadcast data packet may also be transmitted by the second device and received from the first device. At 1008, an operation using the data identifying the second device may be executed.

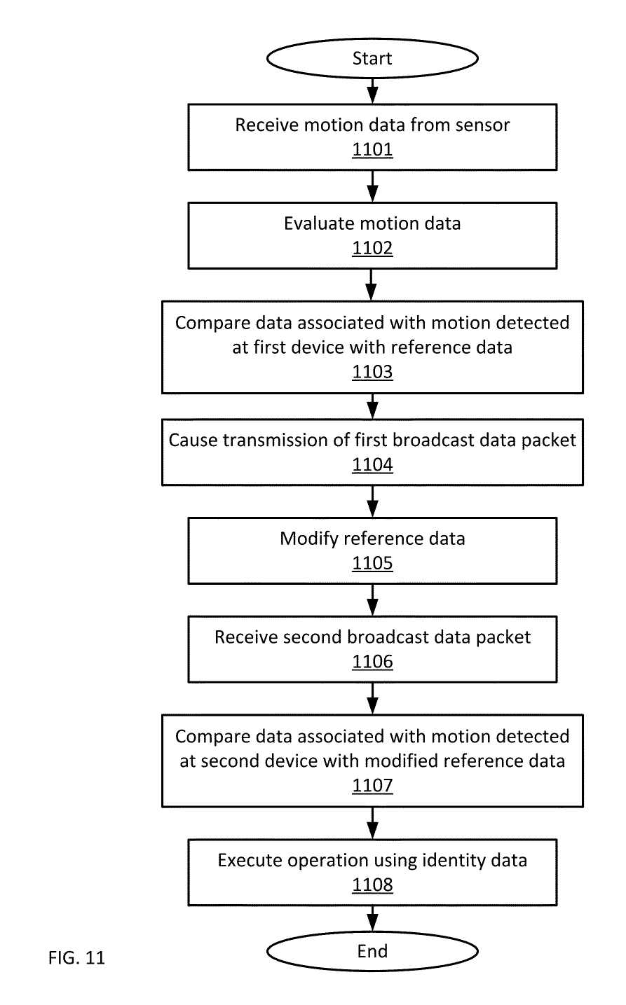

FIG. 11 illustrates yet another exemplary process for an interaction manager, according to some examples. At 1101, like 1001 in FIG. 10, motion data may be received at a sensor coupled to a first device. For example, a high-five motion is detected. At 1102, like 1002 in FIG. 10, the motion data may be evaluated to generate data associated with motion. For example, data associated with motion may be a sudden drop in acceleration, corresponding to the impact made during the high-five, and the time at which the drop was detected by the first device. At 1003, the data associated with motion detected at the first device may be compared with reference data stored in a memory coupled to the first device to determine a match. A match may trigger or initiate a process to detect, form, perform, or execute an interaction with a second device. A match may also identify the reference data that is expected or is likely included in a broadcast data packet received from the second device. For example, a reference data may be a sudden drop in acceleration. At 1104, like 1004 in FIG. 10, transmission of a first broadcast data packet including data identifying the first device and data associated with motion detected at the first device is caused. At 1105, the reference data that was determined to match the data associated with motion detected at the first device is modified or customized. For example, the reference data indicating a sudden drop in acceleration may be modified to add the actual time that was detected by the first device when the drop occurred. As another example, the reference data stored in memory may specify a range of ratios between two components of acceleration. It may be modified so that the range of ratios is narrowed based on the actual ratio that was detected by the first device. The modified reference data may be configured to be compared with data associated with motion detected at a second device. The modified reference data may be stored in memory and used again in the future, or it may be discarded after one use. At 1106, a second broadcast data packet is received from a second device. The second broadcast data packet may include data identifying the second device and data associated with motion detected at the second device. For example, the data associated with motion detected at the second device may include a sudden drop in acceleration and a time at which the drop was detected at the second device. At 1107, the data associated with motion detected at the second device is compared with the reference data after it has been modified by the data associated with motion detected at the first device. For example, the time at which the drop was detected at the first device and the time at which the drop was detected at the second device are compared. For example, the two times are substantially similar, and a match may be found. At 1108, an operation using the data identifying the second device is executed.

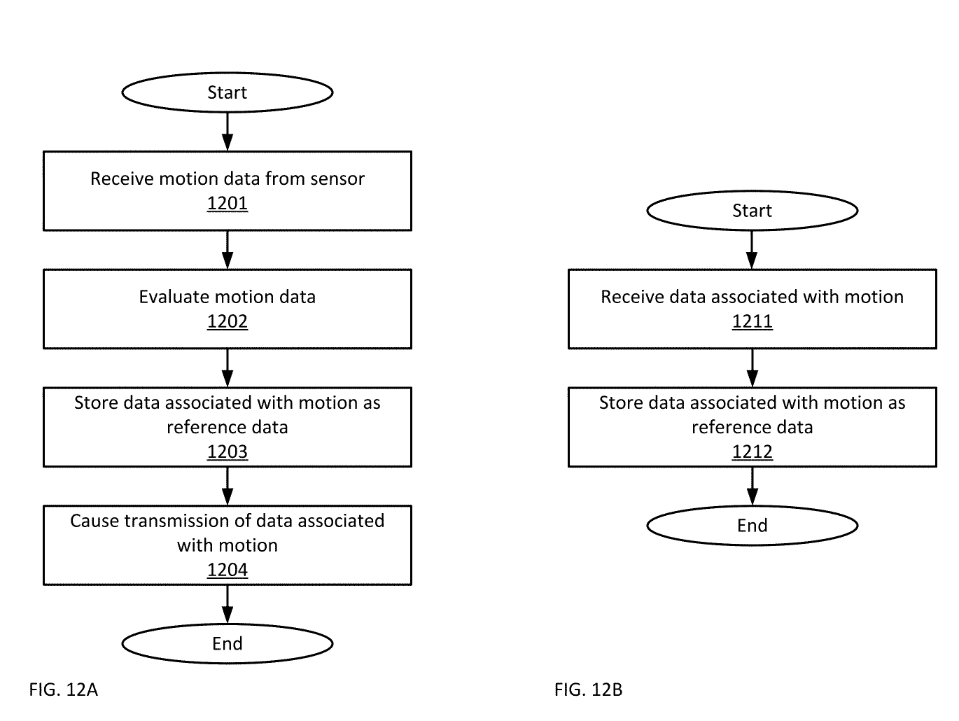

FIGS. 12A and 12B illustrate exemplary processes for a teaching and learning mode of an interaction manager, according to some examples. FIG. 12A illustrates a teaching mode on a first device. At 1201, motion data may be received from a sensor coupled to a first device. For example, a user wearing the first device does a “secret handshake.” At 1202, the motion data may be evaluated to generate data associated with motion. At 1203, the data associated with motion may be stored as reference data in a memory coupled to the first device. Thus, a new reference data corresponding to the secret handshake is created for future use. At 1204, transmission of the data associated with motion is caused. The data may be transmitted to a second device, to teach the second device the new reference data. FIG. 12B illustrates a learning mode on a second device. At 1211, data associated with motion detected at the first device is received at the second device. At 1212, the data associated with motion is stored as reference data in a memory coupled to the second device. Thus, for example, the reference data corresponding to the secret handshake is the same on the first device and the second device.

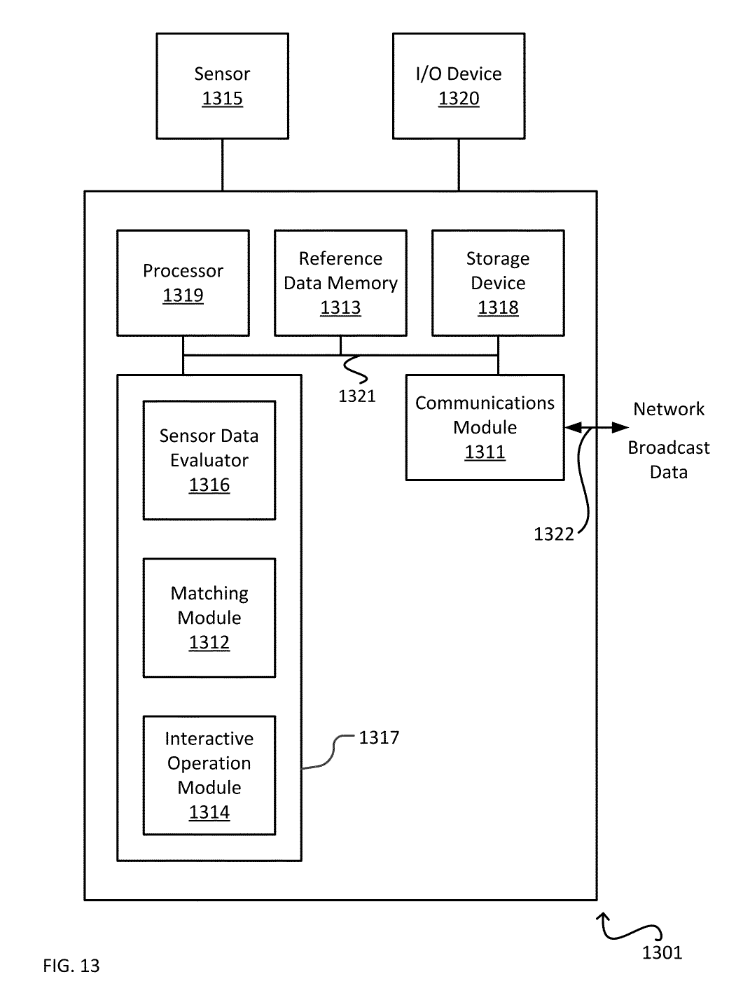

FIG. 13 illustrates an exemplary computer system suitable for use with an interaction manager, according to some examples. In some examples, computing platform 1301 may be used to implement computer programs, applications, methods, processes, algorithms, or other software to perform the above-described techniques. Computing platform 1301 includes a bus 1321 or other communication mechanism for communicating information, which interconnects subsystems and devices, such as processor 1319, system memory 1317 (e.g., RAM, etc.), reference data memory, 1313, storage device 1318 (e.g., ROM, etc.), a communication module 1311 (e.g., an Ethernet or wireless controller, a Bluetooth controller, etc.) to facilitate communications via a port on communication link 1322 to communicate, for example, with a computing device, including mobile computing and/or communication devices with processors. Processor 1319 can be implemented with one or more central processing units (“CPUs”), such as those manufactured by Intel® Corporation, or one or more virtual processors, as well as any combination of CPUs and virtual processors. Computing platform 1301 exchanges data representing inputs and outputs via input-and-output devices 1320, including, but not limited to, keyboards, mice, audio inputs (e.g., speech-to-text devices), user interfaces, displays, monitors, cursors, touch-sensitive displays, LCD or LED displays, and other I/O-related devices. An interface is not limited to a touch-sensitive screen and can be any graphic user interface, any auditory interface, any haptic interface, any combination thereof, and the like. Computing platform 1301 may also receive sensor-related input from sensor 1315, including an accelerometer, a gyroscope, a GPS receiver, and the like.

According to some examples, computing platform 1301 performs specific operations by processor 1319 executing one or more sequences of one or more instructions stored in system memory 1317, and computing platform 1301 can be implemented in a client-server arrangement, peer-to-peer arrangement, or as any mobile computing device, including smart phones and the like. Such instructions or data may be read into system memory 1317 from another computer readable medium, such as storage device 1318. In some examples, hard-wired circuitry may be used in place of or in combination with software instructions for implementation. Instructions may be embedded in software or firmware. The term “computer readable medium” refers to any tangible medium that participates in providing instructions to processor 1319 for execution. Such a medium may take many forms, including but not limited to, non-volatile media and volatile media. Non-volatile media includes, for example, optical or magnetic disks and the like. Volatile media includes dynamic memory, such as system memory 1317.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1321 for transmitting a computer data signal.

In some examples, execution of the sequences of instructions may be performed by computing platform 1301. According to some examples, computing platform 1301 can be coupled by communication link 1322 (e.g., a wired network, such as LAN, PSTN, or any wireless network) to any other processor to perform the sequence of instructions in coordination with (or asynchronous to) one another. Computing platform 1301 may transmit and receive messages, data, and instructions, including program code (e.g., application code) through communication link 1322 and communication interface 1311. Received program code may be executed by processor 1319 as it is received, and/or stored in memory 1317 or other non-volatile storage for later execution.

In the example shown, system memory 1317 can include various modules that include executable instructions to implement functionalities described herein. In the example shown, system memory 1317 includes a sensor data evaluator 1316, a matching module 1312, and an interactive operation module 1314. Reference data memory 1313 may also be accessed by processor 1319.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
receiving a broadcast data packet at a first device, the broadcast data packet comprising:
data identifying a second device, and
data associated with a motion detected at the second device;
comparing the data associated with the motion to reference data stored in a memory coupled to the first device to determine a match; and
executing an operation of the first device using the data identifying the second device.

2. The method of claim 1, wherein the reference data comprises a threshold of an acceleration.

3. The method of claim 1, further comprising:
generating data associated with another motion detected at the first device;
comparing the data associated with the another motion to the reference data stored in the memory coupled to the first device to determine a match; and
modifying the reference data using the data associated with the another motion, wherein the reference data after being modified is configured to be compared to the data associated with the motion.

4. The method of claim 3, wherein the modifying the reference data comprises including in the reference data a time at which an acceleration of the another motion exceeds a threshold is detected at the first device.

5. The method of claim 1, further comprising:
generating data associated with another motion detected at the first device; and
causing transmission of another broadcast data packet comprising data identifying the first device and the data associated with the another motion.

6. The method of claim 1, further comprising receiving another broadcast data packet comprising data representing an acknowledgement.

7. The method of claim 1, wherein the operation comprises causing creation of a Bluetooth communication link with the second device.

8. The method of claim 1, wherein the operation comprises causing transmission of a data signal to the second device.

9. The method of claim 1, wherein the data associated with the motion comprises data representing a time since an end of the motion.

10. The method of claim 1, wherein the data associated with the motion comprises data representing a ratio of one component of a parameter associated with the motion to another component of the parameter associated with the motion.

11. The method of claim 1, wherein the data associated with the motion comprises data representing a sampling of the data associated with the motion at a predetermined frequency.

12. The method of claim 1, wherein the data associated with the motion comprises data representing the number of times a parameter associated with the motion is detected.

13. The method of claim 1, further comprising comparing a time since an end of the motion detected at the second device to a time since an end of another motion detected at the first device to determine a match.

14. A device, comprising:
a memory coupled to a first device, the memory configured to store a broadcast data packet comprising data identifying a second device and data associated with a motion detected at the second device, and to store reference data associated with an operation; and
a processor coupled to the first device, the processor configured to compare the data associated with the motion to the reference data to determine a match, and to execute the operation using the data identifying the second device.

15. The device of claim 14, wherein the processor is further configured to receive data associated with another motion detected at the second device, and the reference data comprises the data associated with the another motion.

16. The device of claim 14, wherein the processor is further configured to randomly select a channel to receive the broadcast data packet.

17. The device of claim 14, wherein the operation comprises causing creation of a secure communication link with the second device.

18. The device of claim 14, wherein the operation comprises causing transmission of a data signal to a server, wherein the data signal comprises the data identifying the second device.

19. (canceled)

20. The device of claim 14, wherein the data associated with the motion comprises data representing a time at which a parameter associated with the motion exceeds a threshold.

21. The device of claim 14, wherein the broadcast data packet is an advertising packet using a Bluetooth protocol.
